(19) United States
(12) Patent Application Publication
(10) Pub. No.: US 2022/0277361 A1
(43) Pub. Date: Sep. 1, 2022

(54) METHODS OF COMPUTER-IMPLEMENTED IMAGE SENSOR-INITIATED TRANSACTIONS FOR PURCHASES WITH TRANSACTION FEES PAID TO MULTIPLE PARTIES

(71) Applicant: Laterpay AG, Steinhausen (CH)

(72) Inventor: Cosmin-Gabriel ENE, Zollikon (CH)

(21) Appl. No.: 17/635,309

(22) PCT Filed: Aug. 17, 2020
(86) PCT No.: PCT/EP2020/072981

§ 371 Date: Feb. 14, 2022

Related U.S. Application Data
(60) Provisional application No. 62/887,166, filed on Aug. 15, 2019.

(51) Int. Cl. G06Q 30/02; G06Q 30/06; G06Q 20/20

(52) U.S. Cl. CPC G06Q 30/0281; G06Q 30/0214; G06Q 30/0611; G06Q 30/0639; G06Q 20/201

(57) ABSTRACT

A computer-implemented method for initiating an on-line purchase transaction with transaction payments to multiple parties, including the steps of: a) receiving information from an internet-accessible mobile device indicative of a item identifier and pot location information indicative of a purchase location; b) processing the item identifier information to identify at least one good or service, c) processing the location information to determine a physical location of an associated merchant, d) initiating an electronic search to find offers from on-line merchants for the one good or service, e) processing the on-line merchant offers, f) transmitting information at least one of the found offers, g) receiving an acceptance of one of the offers, h) transmitting a signal to an on-line merchant providing the accepted offer, and i) transmitting a signal to the associated merchant indicating an amount payable to the first merchant upon payment to the on-line merchant for the offer.

### FIELD OF THE INVENTION

This disclosure pertains to computer-implemented methods for electronic transactions initiated by means of a sensor coupled with a user electronic device, and more particularly, computer-implemented methods for electronic transactions initiated by means of a user electronic device coupled to a sensor for sensing items indicative of products or services available at a merchant physical location.

### BACKGROUND

Consumers may often appreciate the convenience of a merchant “brick and mortar” physical location for viewing, evaluating and obtaining a product or service directly and for immediate use. However, in order to offset the costs of providing and maintaining these physical locations, product prices are often higher than prices charged for the same products by on-line merchants. In addition, for products purchased in large quantities, it may be preferable or easier for a consumer to arrange for a mail or carrier-based delivery as provided by an on-line merchants rather than personally and awkwardly carrying out such a large quantity of products from a merchant physical location.

As a result, consumers may often be motivated to visit a merchant physical location simply to view and evaluate a product or service, and then proceed to order the product or service from an on-line merchant, for example, to obtain better pricing and/or easier delivery. In this case, the merchant maintaining the physical location receives at most a modest return if the consumer decides to purchase a small quantity of the product or service for immediate use. More likely, the merchant may receive no compensation if the consumer opts to make no purchase at all. In time and to the detriment of the consumer, the merchant may decide against maintaining the physical location or providing immediate access to products and services that are also available from on-line merchants. It would benefit consumers if merchants operating physical locations could be compensated for providing access to products and services that consumers may choose to purchase in volume from on-line merchants. It would also be of benefit to consumers to have a convenient way to receive offers from on-line merchants for product and service purchases at or near the time that consumers may be evaluating the products and services at a merchant physical location.

### SUMMARY

By way of example, aspects of the present disclosure are directed to methods and systems for initiating an on-line purchase transaction with transaction payments to multiple parties for products and services viewable in a “brick and mortar” merchant physical location or store.

In accordance with aspects of the present disclosure, the disclosed computer-implemented method includes the steps of: a) receiving information from an internet-accessible mobile device, the information indicative of a item identifier for at least one good or service, and location information indicative of the location from which the mobile device transmitted the information; b) processing the received item identifier information for identifying the at least one good or service, c) processing the received location information to determine if the location is proximate a physical location of a first merchant, d) initiating an electronic search to find offers from on-line merchants for the identified at least one good or service, e) processing on-line merchant offers found in performance of the initiating step, f) transmitting information to the mobile device regarding at least one of the found on-line merchant offers in connection with the processing step e), g) receiving from the mobile device, information regarding an acceptance of one of the found on-line merchant offers by a user of the mobile device, h) transmitting a signal to the on-line merchant of the accepted offer providing information indicative of the accepted offer; and i) transmitting a signal to a computer system of the first merchant indicating an amount payable to the first merchant upon payment to said on-line merchant for the accepted found offer.

In accordance with an additional aspect of the disclosure, the signal transmitted to the computer system of the first merchant indicating the amount payable to the first merchant is at least one of a percentage of the purchase price of the accepted on-line merchant offer, fixed fee or negotiated fee.

In accordance with further aspects of the disclosure, the signal transmitted to the on-line merchant includes information of a quantity of the at least one good or service to be purchased from the on-line merchant for the accepted found offer.

In accordance with further aspects of the disclosure, the information indicative of the item identifier for at least one good or service is an image captured by the mobile device of a label or tag in connection with the at least one good or service.

In accordance with other aspects of the disclosure, the information transmitted to the mobile device includes time periods for which the one or more of the on-line merchant offers are valid.

In accordance with further aspects of the disclosure, the method further includes the step of confirming whether the information received from the mobile device regarding the acceptance by a user of the mobile device of one of the found on-line merchant offer is within the time period for which said offer is valid.

In accordance with further aspects of the disclosure, the method further includes the step of transmitting to the mobile device an indicator that the acceptance by a user of the one of the found on-line merchant offer is invalid if confirmation step determines that the acceptance was made after the time period for which said offer is valid.

In accordance with additional aspects of the disclosure, the start of the time period for which said offer is based on information provided by the mobile device of a time at which an image is captured by the mobile device of a label in connection with the at least one good or service.

This SUMMARY is provided to briefly identify some aspects of the present disclosure that are further described below in the DESCRIPTION. This SUMMARY is not intended to identify key or essential features of the present disclosure nor is it intended to limit the scope of any claims.

### BRIEF DESCRIPTION OF THE DRAWING

A more complete understanding of the present disclosure may be realized by reference to the accompanying drawing in which:

FIG. 1 depicts an exemplary network useable in accordance with aspects of the present disclosure; and

FIG. 2 depicts an exemplary message sequence diagram in accordance with aspects of the present disclosure.

### DETAILED DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements later developed that perform the same function, regardless of structure.

Unless otherwise explicitly specified herein, the drawings are not drawn to scale.

Aspects of the present disclosure are directed to methods and systems for initiating a convenient on-line purchase transaction with transaction payments to multiple parties for products and services viewable in a “brick and mortar” merchant physical location or store, based on the sensing of an item identifier present on or in proximity to a product or to a service display by, for example, a mobile device (also termed a “User Equipment Device,” or “UE device”) equipped with a sensor (for example, a digital camera device). Such devices may include, but are not limited to, personal digital assistants (PDAs), smartphones, tablet devices, and other devices capable of executing software application programs that may have been pre-installed in a non-activated state on the device, or are dynamically installed, for example, in a non-activated state via a network connection to a system that offers software applications and features for download and licensing, e.g., App Store, (“AS”). These software applications are programs stored in the UE device to be activated and then executed by a processor of the device when execution is triggered, that is when the application is started.

In accordance with the present disclosure, the UE device may be configured with an operating system and other software applications. A local memory of the UE device may preferable store license information for one or more of the installed apps that the UE device is currently licensed to use.

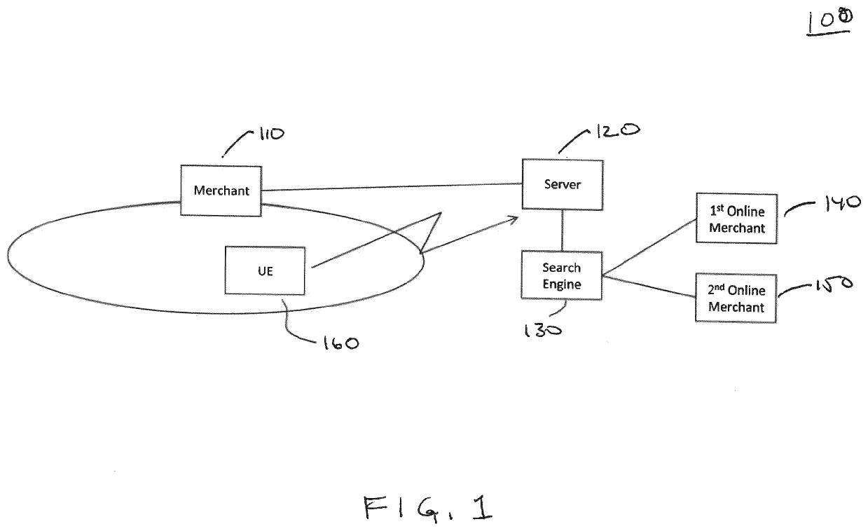

With reference to the drawing figures, FIG. 1 shows a network 100 comprising a computer system of a first merchant (“Merchant Computer 110”) that is connected to a server computer (“Server 120”). The Server 120 is connected to a computer system (“Search Engine 130”) that is enabled to perform electronic searches to find offers from on-line merchants for goods and/or services. The Search Engine 130 may preferably be able to access, by for example the internet, computer servers of a variety of on-line merchants. By way of example, two on-line merchants (“On-line Merchants 140, 150”) are shown in FIG. 1.

The network also comprises a mobile device (user equipment, “UE 160”) that has access to the internet via one or more wireless communication interfaces. Via one or more of the wireless communication interfaces, the UE 160 is capable of being connected at least to the Server 120.

In some embodiments of the present enclosure, it is a prerequisite that the UE 160 and the Merchant Computer 110 are in proximity, which proximity is indicated in FIG. 1 as an ellipsis in which both the UE160 and the Merchant Computer 110 reside. Proximity may represent the distance between both nodes (the UE160 and the Merchant Computer 110), which enables for direct communication via a short-range communication means like Wireless LAN (WLAN or WI-FI), BLUETOOTH, ZIGBEE or the like. Proximity may alternatively mean that both nodes of the Network 100 (UE160 and Merchant Computer 110) are able to access the same WLAN network, as for example spanned by a WLAN access point. Proximity may also mean that the two nodes have a line-of-sight to each other, or that the geographical distance between both is lower or equal to a pre-defined maximum distance for facilitating short-range communications. Other examples of proximity in the same general sense are fully contemplated by the present disclosure.

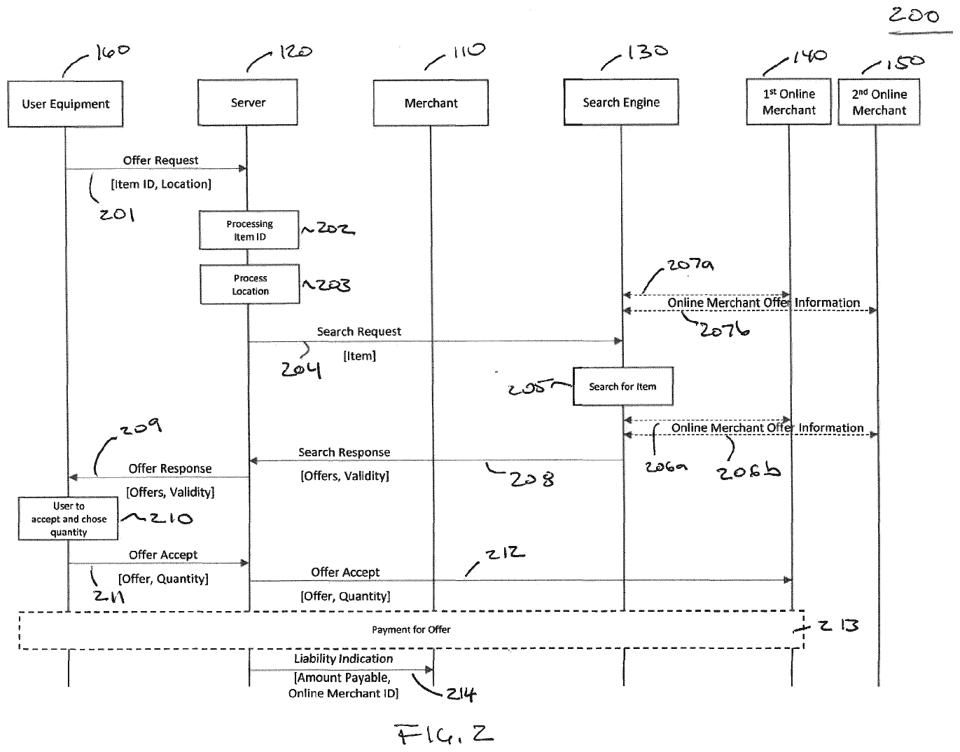

FIG. 2 illustrates a message sequence chart 200 according to further aspects of the present disclosure that depicts a method carried out over the system 100 for initiating a purchase transaction with transaction payments to multiple parties. The figure is organized with reference to the six nodes 110-160 which are described above in relation to FIG. 1.

The user of a UE 160 (“consumer”) may find a product good or service that is immediately available in a “brick and mortar” store of a merchant, and desire to determine whether the good or service may also be available within a predetermined time period from an on-line supplier (for example, at a lower cost and/or providing for a more convenient delivery, especially in large quantities). In this case, as illustrated at step 201 of the sequence depicted in FIG. 2, the user may proceed to initiate a request for an offer to purchase a good or service on-line via the UE 160. To facilitate the request, the merchant may place identification tags on or near the goods or a service representation, in order to uniquely identify these products. The tags may be human-readable, or be machine-readable via a sensor incorporated with the UE 160 for reading QR codes, RFID tags or the like. One read, the UE 160 then has an identification of the good or service, in general the item. The UE 160 is further able to identity its location to a certain accuracy. The location may be known in form of the shop the UE is current is in, the information for example gained from the tag of the item or of another tag. The location may also be determined via a mobile positioning system, e.g. GPS, cellular mobile positioning or any other positioning system.

The inventive method begins with the UE 160 transmitting to the Server 120 an Offer Request message 201 comprising at least an identifier of the item (for example, Item ID) for which an offer is requested, and a current location of the UE 160.

The Server 120 proceeds at step 202 to process the received Item ID to identify the good or service that is requested. The identification may, for example, comprise a look-up in an item database co-located with the server or alternatively present at a different location and connected to the server. The identification may use also other information available, e.g. an identification of the UE 160 or the user (not shown in the figure), the location information, the time of day, date or any other information to identify a good or service that is most likely referenced by the received item ID.

At step 203, the Server 120 processes the location information in order to determine whether the UE 160 is in proximity to the Merchant 110. The processing step 203 may, for example, include a query directed to Merchant database that is connected to the Server 120 and provides information about multiple Merchants and their respective locations so the Server 120 can determine the Merchant 110 in the shop of which the UE 160 currently resides with the highest likelihood. The processing step 203 may then, in addition or alternatively, include a look-up query on a map, or a step to determine proximity between the UE 160 and the Merchant 110 by way of comparing network names or addresses the nodes have in common. Alternatively, the location information may include beacon information received by the UE 160 and provided in the Offer Request 201 and the processing step 203 may include a look-up query of the beacon information in a database to determine an associated Merchant 110.

At step 204, the Server 120 initiates an on-line search for the identified good or service to be conducted by the Search Engine 130. The Search Engine 130 may be implemented on the Server 120 itself, in which case the communications between the Search Engine 130 and Server 120 as illustrated in FIG. 2 are only indications of a possible model of Server-internal inter-process communication. The Search Engine 130 may alternatively be implemented as a separate entity, either a virtual entity in the form of a process running on the same hardware or a separate hardware component. The Search Engine 130 may, for example, be an internet-accessible search engine. Step 204 may in that case include transmitting over the internet a Search Request message to the Search Engine 130 comprising at least some information identifying the item, but not necessarily the Item ID received by the Server.

At step 205, the Search Engine 130 then performs an on-line search for the item at a multitude of on-line merchants. By way of example, FIG. 2 depicts two merchants and the Search Engine searches the 1st On-line Merchant 140 and the 2nd On-line Merchant 150 for the item in the form of requesting and receiving On-line Merchant Offer Information at respective steps 206a, 206b from the respective on-line merchant. The On-line Merchant Offer Information may preferably include information about the offered goods or services, a price and a validity period or expiry time of the provided offer information.

The Search Engine 130 may perform on-line searches in different modes:

A first mode, in which On-line Merchant Offer Information is received by the Search Engine 130 before the Search is initiated. In this mode, the Search Engine 130 may collect on-line information before hand at any point in time, probably even before the inventive procedure started. The on-line information is then stored by the Server 120 in a search-optimized way so that when a Search Request message is received at step 204, search results can be provided very quickly. This is indicated in FIG. 2 as On-line Merchant Offer Information 207a, 207b.

A second mode, in which requesting and receiving On-line Merchant Offer Information by the Search Engine is triggered by receiving the Search Request message. In this mode, at steps 206a, 206b, the Search Engine 130 requests the On-line Merchant Offer Information after reception of the Search Request.

A third mode includes a combination of the first and second or similar modes.

At step 208, the results of the on-line search are provided back to the Server 120, preferably in a Search Response message comprising offers of the item from one or more of the on-line merchants, and preferably with validity periods or expiry timers. The Server 120 may then forward the offers and related information in an Offer Response message to the UE 160 at step 209.

The UE 160 may then display or otherwise present (for example, by audio representing voiced statements) the received offers to the user of the UE 160, and allow the user to select, in case multiple offers for the same item are received, and accept one offer at step 210. The UE 160 may also preferably allow the user to select the quantity of items to be ordered.

Alternatively, in lieu of a user selection, the UE 160 may be configured to select and accept one of the offers (for example, the offer with the lowest per unit cost) on behalf of the user. Optionally, before acceptance, the UE 160 authenticates the user of the UE 160. If the Offer Response message at step 209 contained a time validity time information, the UE 160 may ensure that an option to select and accept an offer is only presented to the user as long as it is deemed valid in time. The selected and/or accepted offer, including quantity information as selected by the user, is communicated to the Server in an Offer Accept message at step 211.

The Server 120, in response to receiving the Offer Accept message from the UE, transmits a respective Offer Accept message at step 212 to the on-line merchant 140 related to the accepted offer. The Offer Accept message may comprise a quantity, if selected by the user.

The on-line merchant 140, by way of example in FIG. 2, may then initiate a payment procedure 213 with the UE 160. This step is not further elaborated, as well-known payment methods may be used. This step may also be performed at a later point in time, outside the scope of FIG. 1.

At step 214, the Server 120 transmits to the Merchant 110 a Liability Indication representing informing the Merchant about the payment terms of the on-line merchant 140 having made the selected offer to pay to the merchant a certain agreed amount upon payment of the item by the user of the UE 160. The amount may be indicated in the Liability Indication message, for example, as an absolute amount, as a percentage of the total price together with the total price information, or as a previously agreed and negotiated fee. The amount may also be calculated as a combination fee having fixed and percentage-based components. The Server 120 may also only indicate to the Merchant 110 the price to be paid for the item to the on-line merchant 140, and rely on the Merchant 110 to apply a service level agreement with the on-line merchant 140 that provides the percentage payable to the Merchant 110 by the on-line merchant 140. The Liability Information message may also preferably include an On-line Merchant ID that provides to the Merchant the information who is liable for paying the percentage of the item price.

It will be understood that, while various aspects of the present disclosure have been illustrated and described by way of example, the invention claimed herein is not limited thereto, but may be otherwise variously embodied within the scope of the following claims. For example, it should be understood that while the ticket computer server 50 determined the payment method in step 180 of FIG. 2, such server may rely on instructions from a third party payment service provider, such as the operators of the deferred payment server 60, to only offer to the UE 40, the immediate payment option for the requested transaction. Further, the ticket computer server 50 and deferred payment server 60 have been described with regard to FIG. 2 as separate servers for ease of understanding only, it is further contemplated that the operations of these servers may be performed by a single server, or a greater number of servers.

The following table lists the reference characters and names of features and elements used herein: Reference characters assigned to method steps are not listed.

| Ref. char. | Feature or element |
|---|---|
| 100 | Network |
| 110 | Merchant Computer |
| 120 | Server |
| 130 | Search Engine |
| 140 | 1^{st} On-line Merchant |
| 150 | 2^{nd} On-line Merchant |
| 160 | User Equipment |

We claim:

1. A computer-implemented method for initiating a purchase transaction with transaction payments to multiple parties, the method comprising the steps of:
a. receiving information from an internet-accessible mobile device, the information indicative of a item identifier for at least one good or service, and location information indicative of the location from which the mobile device transmitted the information;
b. processing the received item identifier information for identifying the at least one good or service;
c. processing the received location information to determine if the location is proximate a physical location of a first merchant;
d. initiating an electronic search to find offers from on-line merchants for the identified at least one good or service;
e. processing on-line merchant offers found in performance of the initiating step;
f. transmitting information to the mobile device regarding at least one of the found on-line merchant offers in connection with the processing step (e);
g. receiving from the mobile device, information regarding an acceptance of one of the found on-line merchant offers by a user of the mobile device;
h. transmitting a signal to the on-line merchant of the accepted offer providing information indicative of the accepted offer; and
i. transmitting a signal to a computer system of the first merchant indicating an amount payable to the first merchant upon payment to said on-line merchant for the accepted found offer.

2. The computer-implemented method of claim 1 wherein the signal transmitted to the computer system of the first merchant indicating the amount payable to the first merchant is at least one of a percentage of the purchase price of the accepted on-line merchant offer, fixed fee or negotiated fee.

3. The computer-implemented method of claim 1 wherein the signal transmitted to the on-line merchant includes information of a quantity of the at least one good or service to be purchased from the on-line merchant for the accepted found offer.

4. The computer-implemented method of claim 1 wherein the information indicative of the item identifier for at least one good or service is an image captured by the mobile device of a label in connection with the at least one good or service.

5. The computer-implemented method of claim 1 wherein the information transmitted to the mobile device in step (e) includes time periods for which the one or more of the on-line merchant offers are valid.

6. The computer-implemented method of claim 5 further comprising the step of confirming whether the information received from the mobile device regarding the acceptance by a user of the mobile device of one of the found on-line merchant offer is within the time period for which said offer is valid.

7. The computer-implemented method of claim 6 further comprising the step of transmitting to the mobile device an indicator that the acceptance by a user of the one of the found on-line merchant offer is invalid if confirmation step determines that the acceptance was made after the time period for which said offer is valid.

8. The computer-implemented method of claim 5 wherein a start of the time period for which said offer is based on information provided by the mobile device of a time at which an image is captured by the mobile device of a label in connection with the at least one good or service.
